(19) United States
(12) Patent Application Publication
(10) Pub. No.: US 2012/0300438 A1
(43) Pub. Date: Nov. 29, 2012

(54) FOLDING SPOTLIGHT

(75) Inventors: Kevin J. Tarter, Wichita, KS (US); David B. Gibson, Wichita, KS (US); Jake L. Hillard, Wichita, KS (US)

(73) Assignee: THE COLEMAN COMPANY, INC, Wichita, KS (US)

(21) Appl. No.: 13/575,647

(22) PCT Filed: Jan. 24, 2011
(86) PCT No.: PCT/US11/22256

§ 371 Date: Jul. 27, 2012

Related U.S. Application Data
(60) Provisional application No. 61/298,874, filed on Jan. 27, 2010.

(51) Int. Cl. F21L 4/00

(52) U.S. Cl. 362/157

(57) ABSTRACT

A hand-held spotlight Includes a handle pivotally connected to the housing, wherein the handle may be locked in multiple positions along an approximately 180-degree arc parallel to the direction of the beam of illumination.

### TECHNICAL FIELD OF THE INVENTION

The present invention is directed to lights, and more particularly to spotlights and other hand-held lighting devices.

### BACKGROUND OF THE INVENTION

In general, a spotlight is a portable electric light, such as a luminaire which can be configured to be held by a user. Hand-held spotlights may be considered a type of flashlight having a wide beam of illumination that can be focused in a desired direction. Spotlights are useful for a variety of different applications, including use for light in the outdoors, backup lighting in a power outage, as a source of light to find an object in a dark location or to enable a user to work in areas of low light. It is desirable to be able to utilize a single spotlight device in a wide range of activities and, as such, it is desirable for the spotlight to function in a hand-held manner, as well as is in resting, propped, or hanging positions.

### SUMMARY OF THE INVENTION

The following presents a simplified summary of some embodiments of the invention in order to provide a basic understanding of the invention. This summary is not an extensive overview of the invention. It is not intended to identify key/critical elements of the invention or to delineate the scope of the invention. Its sole purpose is to present some embodiments of the invention in a simplified form as a prelude to the more detailed description that is presented later.

In accordance with an embodiment, a spotlight is provided. The spotlight includes a handle pivotally attached to the spotlight housing and capable of being moved and temporarily locked between several positions along an approximate 180-degree arc relative to the direction of the beam of illumination.

Other features of the invention will become apparent from the following detailed description when taken in conjunction with the drawings, in which:

### BRIEF DESCRIPTION OF THE DRAWINGS

FIG. 1 is a front perspective view of a spotlight in accordance with an embodiment;

FIG. 2 is right side view of the spotlight of FIG. 1;

FIG. 3 is a side perspective view of the spotlight of FIG. 1, shown in a first stowed position;

FIG. 4 illustrates pivoting movement of the spotlight handle;

FIG. 5 is a left side view of the spotlight of FIG. 1;

FIG. 6 is a cross sectional view of the left side view of FIG. 5, showing the locking mechanism;

FIG. 7 is a front view of the spotlight of FIG. 1;

FIG. 8 is a rear view of the spotlight of FIG. 1;

FIG. 9 is a rear perspective view of the spotlight of FIG. 1;

FIG. 10 is a top view of the spotlight of FIG. 1; and

FIG. 11 is a bottom view of the spotlight of FIG. 1

### DETAILED DESCRIPTION

In the following description, various embodiments of the present invention will be described. For purposes of explanation, specific configurations and details are set forth in order to provide a thorough understanding of the embodiments. However, it will also be apparent to one skilled in the art that the present invention may be practiced without the specific details. Furthermore, well-known features may be omitted or simplified in order not to obscure the embodiment being described.

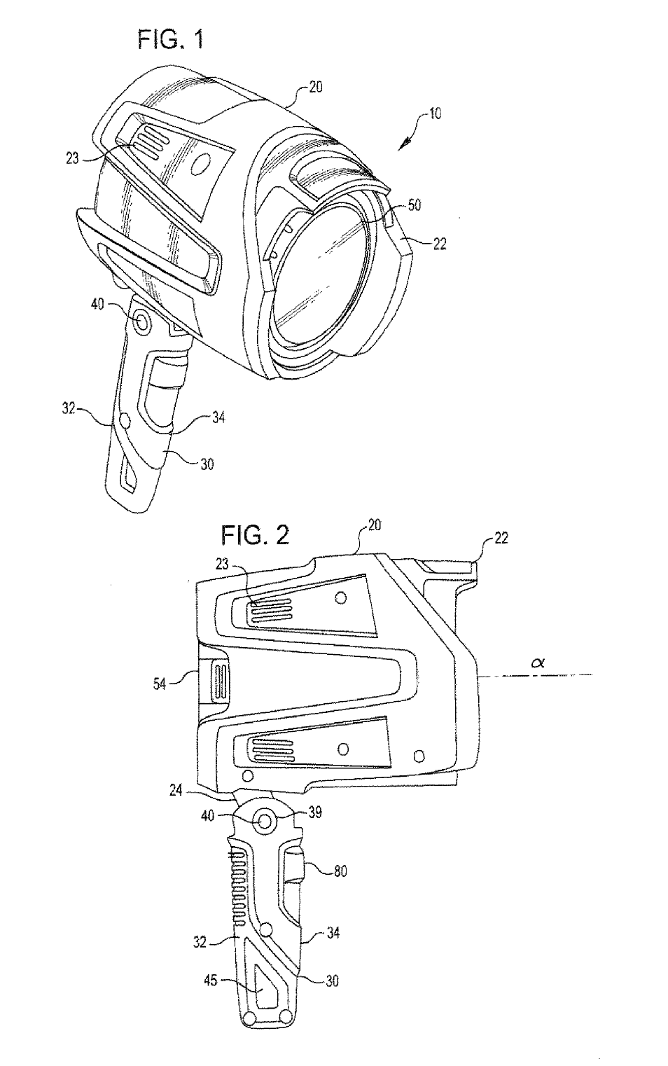

Referring now to the drawings, in which like reference numerals represent like parts throughout the several views, FIG. 1 shows a spotlight 10 in accordance with an embodiment of the invention. The spotlight 10 includes a housing 20 and a handle 30 that is pivotally connected to the housing. The spotlight 10 comprises a transparent lens 50, a reflector 60 mounted behind the lens and a light emitting diode (LED) 70 mounted in the reflector 60 in the conventional manner in order to generate and project a beam of light from the housing 20. The beam of illumination α is projected along a generally longitudinal pathway extending parallel from the housing 20, as shown in FIG. 2. Although an LED is discussed herein, the spotlight may include any form of lamp, including a halogen lamp, an incandescent lamp, a fluorescent lamp, or other lamps or lights.

The spotlight 10 includes internal wiring (not shown in detail) and a power switch 80, to allow a user to turn the light off and on using the switch. Receptacle 54 is located at the rear of housing 20 defining the cavity for receiving an interchangeable power pack 55. Preferably, the power pack 55 may be powered with batteries, rechargeable batteries, fuel cells and the like. It is also within the scope of the present invention for receptacle 54 to receive batteries (not shown) that may be mounted therein and secured with a bottom cap (not shown).

Housing 20 is generally cylindrical or barrel-shaped and includes multiple vents 23 located around the exterior of housing 20 to enable air to circulate through the housing 20 to maintain appropriate environmental conditions for the spotlight, as may be required. Housing 20 may also include a bezel 22 surrounding the circumference of housing 20 around lens 50 to assist in protection of the spotlight 10 from damage during normal usage or in the event that it is dropped.

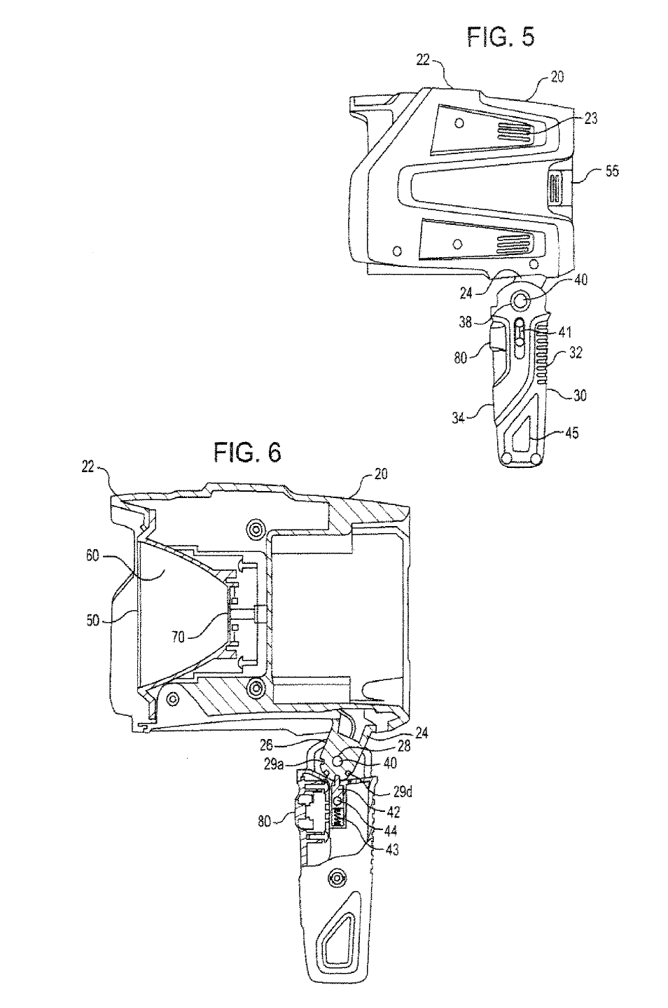

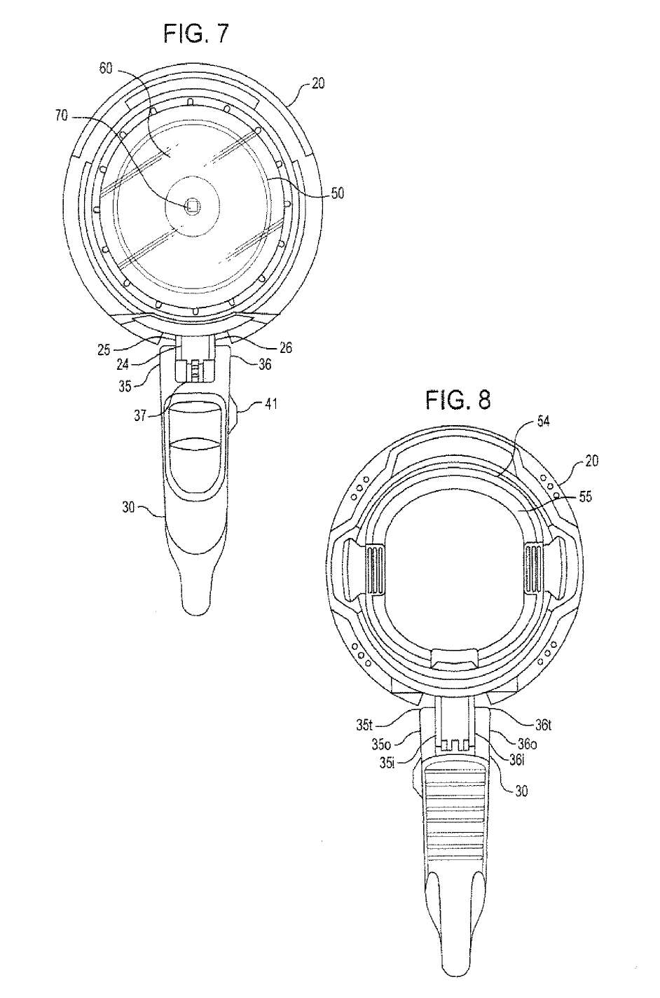

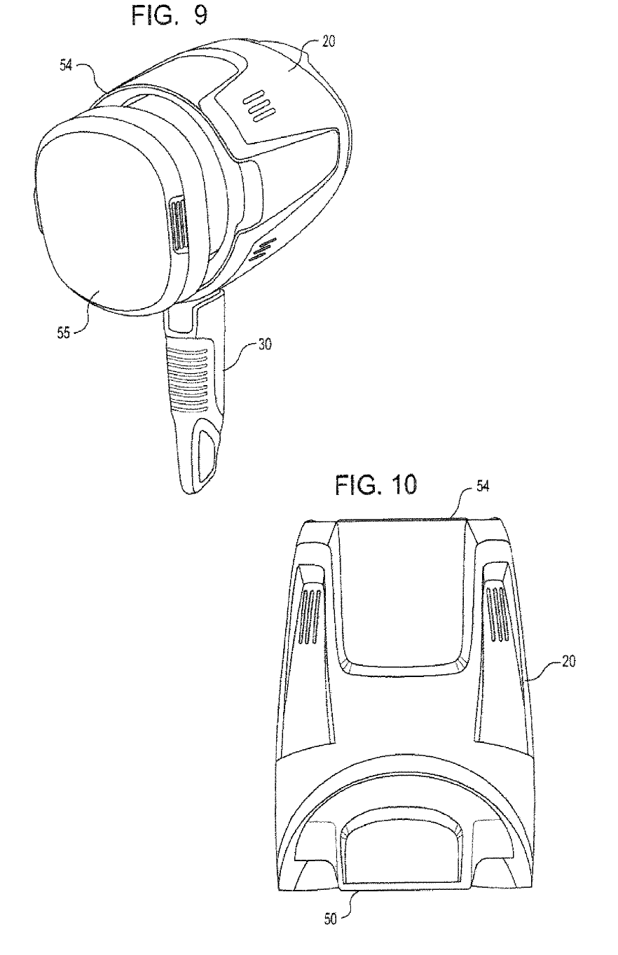

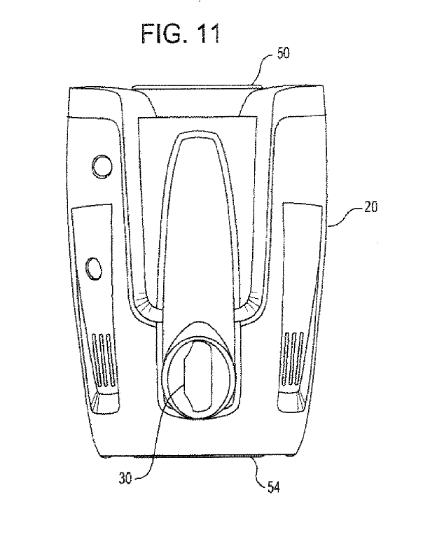

Handle 30 includes a grip 32 and a base 34. Grip 32 may comprise a textured pattern to enable the user to hold the spotlight in a more secure manner. Base 34 comprises side portions 35 and 36, each having upper end 35a and 36a, respectively, that connects to housing 20. Referring to FIGS. 5-7, each upper end 35a and 36a includes a flat inside wall 35i and 36i, a curved outside wall 35o and 360, and a top wall 35t and 36t. The base 34 is formed by the curved side walls 35o and 36o and a flat top wall 37.

The inside and outside walls of the side portions 35 and 36 are provided with circular openings 38 and 39.

The housing 20 includes a pivot portion 24 that extends downward from the housing and is sized to be positioned between the side portion upper ends 35a and 36a of the handle 30. The pivot portion 24 includes a pair of flat side walls 25 and 26 and a U-shaped end wall 27. A circular opening 28 is provided in each of the walls. The pivot portion 24 is preferably formed integrally with at least a portion of the housing 20, but may be formed separately from the housing.

The pivot portion 24 of the housing is pivotally retained between the side portion upper ends 35a and 36a of the handle 20 by a pivot pin 40 which extends through the openings 38, 39 and 28. Handle 30 is retained onto housing 20 by pivot pin 40 and adjusted using a handle locking means.

In an embodiment, a handle locking means comprises pivot portion end wall 27 comprises four female locking features 29a-d located on pivot portion end wall 27. The female locking features 29a-d operate to secure handle 30 in one of four separate angular adjustments in relation to the housing 20 and beam illumination α. Handle 30 includes locking switch 41 that comprises male locking pin 42, spring 43, and interface 44. The male locking pin 42 sits within individual female locking feature 29a, 29b, 29c or 29d to retain handle 30 in the desired position. In operation, locking switch 41 is moved from the resting locked position to the spring-biased unlocked position to move male locking pin 42 downward and out of engagement with one of the female locking features 29a-d. Once the male locking pin 42 is dis-engaged from the female locking feature, handle 30 may be pivoted along an approximately 180-degree arc along the direction of the beam of illumination α to the desired position. Other means for positioning and locking the handle 30 in the desired position relative to the beam of illumination by pivoting the handle along an approximate 180-degree arc are also within the scope of the present invention.

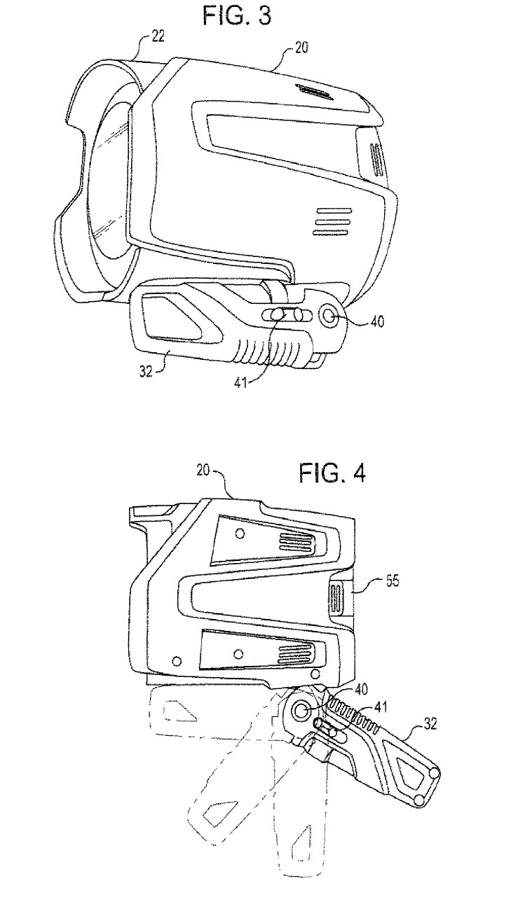

Handle 30 pivots approximately 180 degrees. In the first position, male locking pin 42 is engaged with female locking feature 29a such that handle 30 is in a position approximately parallel to the direction of the beam of illumination α, allowing for compact storage as shown in FIG. 3. In the first position, handle 30 abuts housing 20. As shown in FIG. 4, three additional separate positions are provided for.

In the second position, male locking pin 42 sits within female locking feature 29b such that handle 30 is at a position approximately 45 degrees from the first position, allowing for the spotlight 10 to rest on a surface to direct the beam of light. In the third position, male locking pin 42 sits within female locking feature 29c such that handle 30 is positioned approximately 90 degrees from the first position and from the direction of the beam of illumination α.

In the third position, a more conventional “pistol-style” handle usage is provided for the spotlight wherein the handle 30 is oriented radially from the housing 20 and allows the user to hold the spotlight upright in a manner similar to a pistol, facilitating aiming the beam of light in the desired direction.

Lastly, in a fourth position, the male locking pin 42 sits within female locking feature 29d such that handle 30 is in a position approximately 170 degrees pivoted from the first position. The fourth position allows the spotlight 10 to be hung using the handle hook 45 located at the terminal end of the handle portion. The spotlight 10 can be suspended from a hook, rope, or the like to allow the illumination to be directed downward. The handle locking means allows the light to be hung, rested or propped in the desired position.

Although in the embodiment described the pivot portion 24 comprises four female locking features 29a-d, it should be understood that more or fewer female locking features and corresponding handle positions may be used and still fall within the scope of the present invention. In addition, although four specific handle positions have been described in detail, it is also within the scope of the present invention for the set positions to comprise varying degrees. Similarly, although only approximately 170 degrees of motion along an arc are depicted in the figures, such movement along the arc may be more or less than that amount.

Housing 20 and handle 30 are preferably made of ABS plastic. Other conventional materials used in the art, however, are within the scope of the present invention. Such materials may be of any color. Bezel 22, receptacle 24, handle grip 32 and other elements such as the power switch 80 are preferably made of rubber in order to provide additional protection to the spotlight 10 during usage, absorb impact, provide insulation and provide additional gripping ability. The rubber grip 32 aids in maintaining positioning of the spotlight and beam of illumination when the spotlight is rested or propped on a table or other surface. The rubber may be painted for aesthetic purposes. than rubber that provide similar impact absorbing and traction characteristics, such as over-molded TPE.

Handle 30 includes hook 45 that comprises an aperture located in the handle terminal end. Hook 45 operates as an additional means for directing the beam of illumination. It is also within the scope of the present invention for the hook 45 to comprise a carabineer (not shown) to allow hook 45 to open and be secured through a loop or the like.

Although the spotlight 10 is of general conventional form, embodiments of the invention may be used on other spotlight designs. In addition, the concepts of the present invention may be applied to any lighting appliance, including an electric lantern.

The use of the terms “a” and “an” and “the” and similar referents in the context of describing the invention (especially in the context of the following claims) are to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. The term “connected” is to be construed as partly or wholly contained within, attached to, or joined together, even if there is something intervening. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate embodiments of the invention and does not pose a limitation on the scope of the invention unless otherwise claimed. No language in the specification should be construed as indicating any non-claimed element as essential to the practice of the invention.

Preferred embodiments of this invention are described herein, including the best mode known to the inventors for carrying out the invention. Variations of those preferred embodiments may become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

What is claimed is:

1. A spotlight, comprising:
a housing comprising a power supply and a lamp for generating a beam of illumination along a predefined axis; and
a handle comprising a first end and a second end, wherein the handle is pivotally connected to the housing at the first end and the second end is capable of movement along an arcuate path.

2. The spotlight of claim 1, wherein the beginning and the end of the arcuate path are at points generally parallel to the predefined beam of illumination axis.

3. The spotlight of claim 2, wherein the arcuate path provides approximately 180 degrees of pivotal movement.

4. The spotlight of claim 2 or 3, further comprising handle locking means for temporarily securing the handle in at least two separate positions located along the arcuate path.

5. The spotlight of claim 2 or 3, wherein the power supply comprises an interchangeable power pack.

6. The spotlight of claim 2 or 3, wherein the lamp comprises a member of the set of a light emitting diode, an incandescent lamp, and a fluorescent lamp.

7. A spotlight, comprising:
a housing, said housing defining a longitudinal axis and including means for generating a beam of illumination, said beam of illumination projecting in a direction generally parallel to the longitudinal axis of the housing; and
a handle comprising an elongate body and connected to the housing at a pivot point and capable of rotation about the pivot point such that the handle body is capable of movement along an arc generally parallel to the beam of illumination.

8. The spotlight of claim 7, wherein the generating means comprises a power supply and a lamp.

9. The spotlight of claim 7, wherein the handle body is capable of approximately 180 degrees of rotation about the pivot point.

10. The spotlight of claim 7, further comprising handle locking means for temporarily securing the handle in at least two separate positions along the arc.

11. The spotlight of claim 8, wherein the power supply comprises an interchangeable power pack.

12. The spotlight of claim 8, wherein the lamp comprises a member of the set of a light emitting diode, an incandescent lamp, and a fluorescent lamp.
